(19) United States
(12) Patent Application Publication
(10) Pub. No.: US 2009/0087175 A1
(43) Pub. Date: Apr. 2, 2009

(54) System providing true parallelism adjustment of a camera front standard and film plane and method thereof

(76) Inventor: Guillermo Litman, Long Island City, NY (US)

Correspondence Address: Miskin & Tsui-Yip LLP, 1350 Broadway, Suite 802, NEW YORK, NY, 10018, US

(21) Appl. No.: 11/904,681

(22) Filed: Sep. 28, 2007

(51) Int. Cl. G02B 7/04

(52) U.S. Cl. 396/145

(57) ABSTRACT

A system that provides true parallelism adjustment to a camera's front standard with respect to the film plane. The front standard of a camera is supported by supporting elements that may be lengthened or shortened to adjust the parallelism of the front standard with respect to the film plane. A frame support is provided to determine whether the front standard is parallel to the film plane. The frame support includes two generally U-shape elements supported on the horizontal plane, spaced apart, and parallel to each other by a vertical support. The film plane of the camera is mounted to the lower U-shape element and the front standard rests on the upper U-shape element.

### FIELD OF THE INVENTION

The invention relates to a system that provides true parallelism adjustment to a camera's front standard with respect to the film plane and the method of achieving true parallelism between the front standard and film plane of a camera. In particular, a system providing adjustment of the front standard of a view or folding camera relative to a fixed film plane of the camera to achieve true parallelism.

### BACKGROUND OF THE INVENTION

View cameras have been in used for more than a century. The basic components of a view camera include a camera body, a flexible bellow, a front standard, a film holder, and a lens. The rear of the camera body where the film holder attaches is parallel to the film plane. The flexible bellow extends from the front of the camera body. The other end of the bellow is attached to the front standard, which holds a lens board, which in turn holds the lens.

Usually, large film format cameras (e.g. 4″×5″ & 8″×10″) are view cameras. Different types of films, e.g. roll film or sheet film, can be used with view cameras, depending on the type of film holder being used.

A typical portable view camera, such as Polaroid Models 110 series, 120, 150, 160, 800 or 900, which were originally medium format cameras, or those disclosed in Applicant's U.S. Pat. Nos. 7,181,135, 6,873,794, 6,778,772, and 6,608,971, which are hereby incorporated by reference, has a fixed positioned film plane and a front standard pivotably and generally, relatively, perpendicularly attached to a focusing train, which is slidably mounted on the inside surface of the camera cover, which in turn is hingedly connected to the camera body (see FIG. 1). In some prior art cameras, the pivotable attachment of the front standard to the focusing train allows certain movements of the front standard relative to the film plane to achieve different photographic image results. Depending on the configuration of the front standard attachment to the focusing train, the following movements can be achieved—rise and fall (vertical up and down), shift (horizontal left and right), tilt (altering the lens plane's vertical angle relative to the film plane), and swing (altering the lens plane's horizontal angle relative to the film plane).

A typical attachment of the front standard is pivotal mounting on one edge of the front standard to the focusing train with supporting element(s), such as strut(s), attaching the front standard to the focusing train. A spring and a stop that cooperate with the pivotal mounting or supporting strut(s) are provided to keep the front standard in a supposedly perpendicular position relative to the focusing train and a supposedly parallel position to the film plane. Such spring, stop and strut(s) are manufactured when the camera is produced and any defects in the position and placement of the these components will affect the true parallelism between the front standard and the film plane.

In order to capture photographs free of optical error and distortion and with uniform sharpness, it is important that the front standard is parallel to the film plane. Optical error results from the lack of parallelism is especially noticeable in ultra large format (larger than 11″×14″) cameras. In addition, an error of less than a millimeter in parallelism is enough to cause a 4×5 format image to be unevenly focused. Many view cameras currently in use today date back to many decades. Due to normal wear and tear, mishandling, or the age of these cameras, parallelism between the front standard and the film plane has often deteriorated or misaligned. Over time, the spring, stop and/or strut(s) do not provide true parallelism between the front standard and the film plane, disadvantageously affect the image quality of photographs taken. Even if a camera was manufactured recently it is advantageous to provide a provision to adjust parallelism, as true parallelism would require the adjustment to perfect parallelism. None of the prior art cameras provide an adjustment of the front standard relative to the film plane to achieve true parallelism therebetween. Furthermore, parallelism can only be perfected after the camera is fully assembled and all components of the camera, such as bellow tension, lens weight, etc., are taken into consideration. While older cameras can be affected by wear and tear there is a need to achieve a true relationship between planes and provision to maintain that relationship or restore it over time.

Therefore, there is a need for a system that provides adjustment and a method to adjust the front standard to achieve true parallelism with the film plane of a view camera or a folding camera.

### SUMMARY OF THE INVENTION

The invention provides true parallelism adjustment of a camera front standard with respect to a fixed film plane and the method of achieving true parallelism between the front standard and a fixed film plane of a camera.

Adjustment of a camera front standard is achieved by providing adjustability to the supporting element(s) that holds the front standard in the supposedly parallel position with respect to the film plane. Cameras can be manufactured with adjustable supporting element to alter the length of the supporting element(s). The supporting element(s) of existing cameras may be modified to provide adjustability. Adjustable adaptors may be attached to the supporting element(s) to alter the length of the supporting element(s).

A system is provided to achieve true parallelism between the front standard and the fixed film plane of a camera by facilitating adjustment of the supporting element(s). The system comprises a frame support having two generally U-shape elements, each with two spaced apart extensions beams. The two generally U-shape elements are on the horizontal plane, spaced apart and fixedly parallel to each, and supported by a vertical frame. The rear of a camera, which is parallel to the film plane, is slidably mounted between two extension beams of the lower U-shape element. The front standard of the camera slidably rests on and between the two extension beams of the upper U-shape element. The supporting element of the camera is adjusted to ensure the front standard is properly and evenly rested against the two extension beams of the upper U-shape element to ensure true parallelism between the front standard and the film plane.

### BRIEF DESCRIPTION OF THE DRAWINGS

FIG. 1 is a front portion of a prior art view camera showing the camera body, flexible bellow, front standard, focusing train and supporting struts.

FIG. 2 is a side view of the front standard, focusing train, and supporting struts of FIG. 1.

FIG. 3 is an adjustable adaptor of the system of the present invention that provides adjustment of the front standard of the camera shown in FIGS. 1 and 2.

FIG. 4 is one of the two identical sections of the adjustable adaptor of FIG. 3.

FIG. 5 are the cut supporting struts for receiving the adjustable adaptor of FIG. 3.

FIG. 6 is a frame support of the system of the present invention.

FIG. 7 is the frame support of FIG. 6 with a camera having the adjustable adaptor mounted thereon for adjustment of the front standard.

FIG. 8 illustrates the measuring of a supporting strut having the adjustable adaptor with a digital caliper.

FIG. 9 is the supporting strut having the adjustable adaptor.

FIG. 10 is an exploded view of the adjustable adaptor mounted on a supporting strut.

### DETAILED DESCRIPTION OF THE PREFERRED EMBODIMENTS

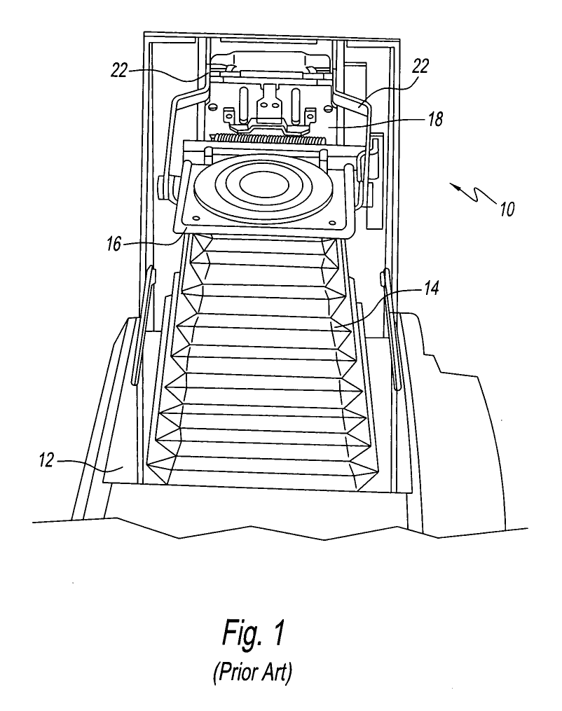

With reference to the drawing wherein the same reference number illustrates the same element throughout, FIG. 1 is the front portion of a prior art view camera 10 showing the camera body 12, the flexible bellow 14, front standard 16, focusing train 18 and supporting struts 22. The flexible bellow 14 extends from the front of the camera body 12. The other end of the bellow 14 is attached to the front standard 16, which is pivotably attached to the focusing train 18 and supported by struts 22. A spring and a stop (not shown) cooperate with the pivotal attachment and/or struts 22 to keep the front standard 16 supposedly perpendicular relative to the focusing train 18.

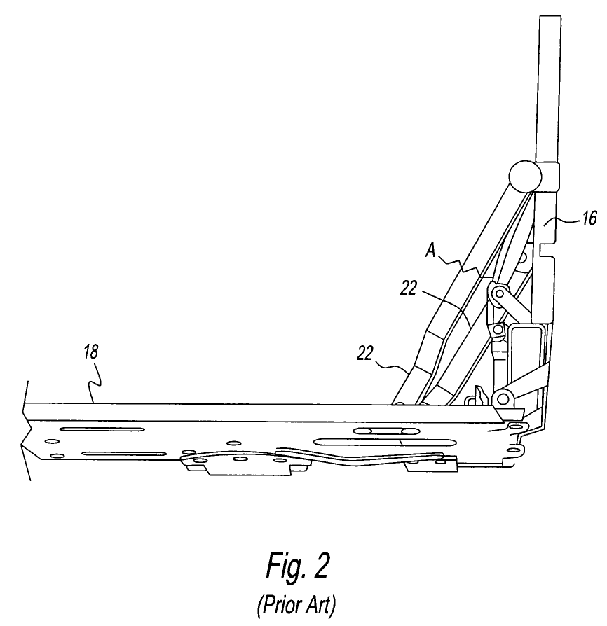

If properly calibrated, as shown in FIG. 2, the front standard 16 is perpendicular to the focusing train 18 to ensure that the front standard 16 is parallel to the film plane (not shown) on the rear of the camera body 12. However, due to normal wear and tear, mishandling, and the age of the camera 10, the front standard 16, as supported by the focusing train 18 and the struts 22, is not parallel to the film plane. Camera 10 has no provision for adjusting the front standard 16 to ensure parallelism between the front standard 16 and the film plane.

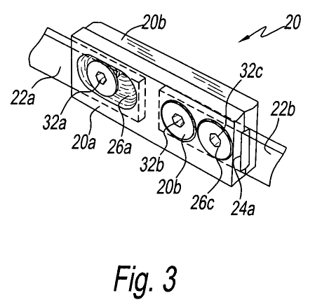

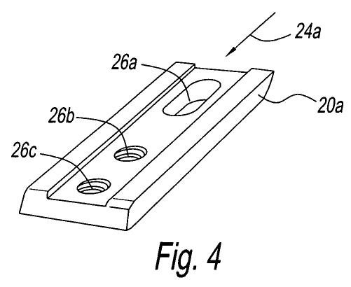

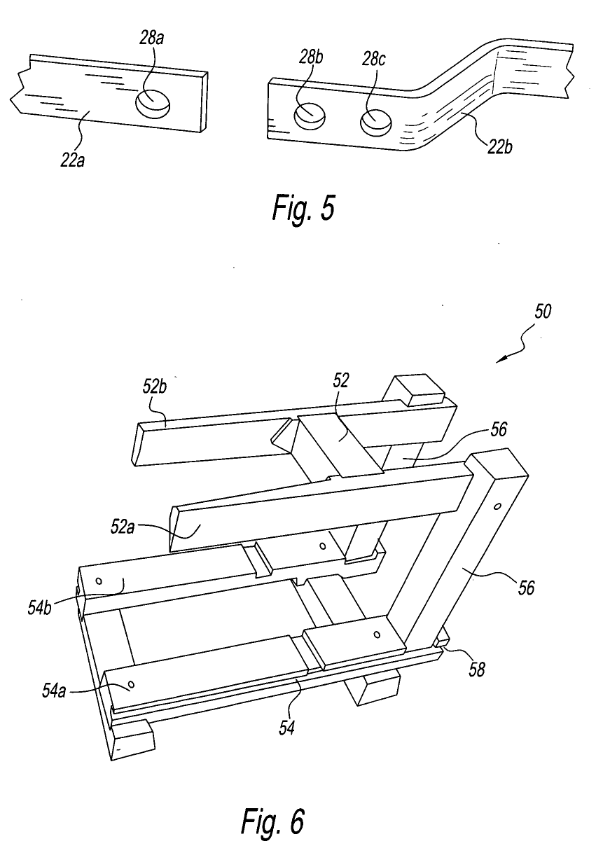

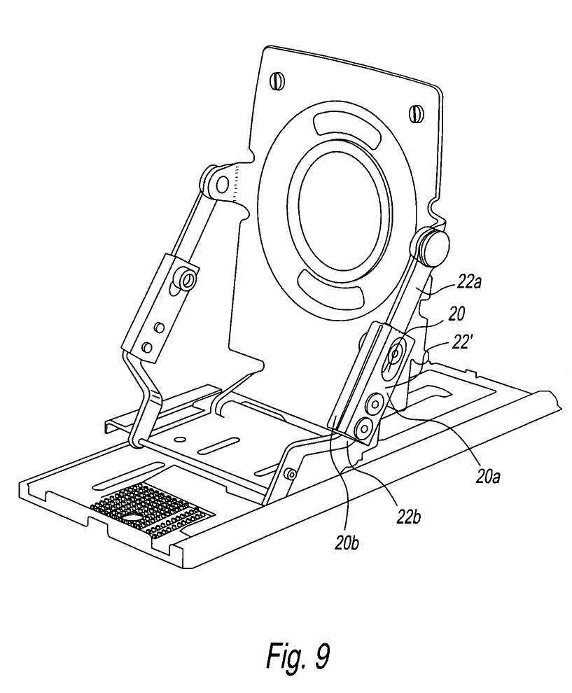

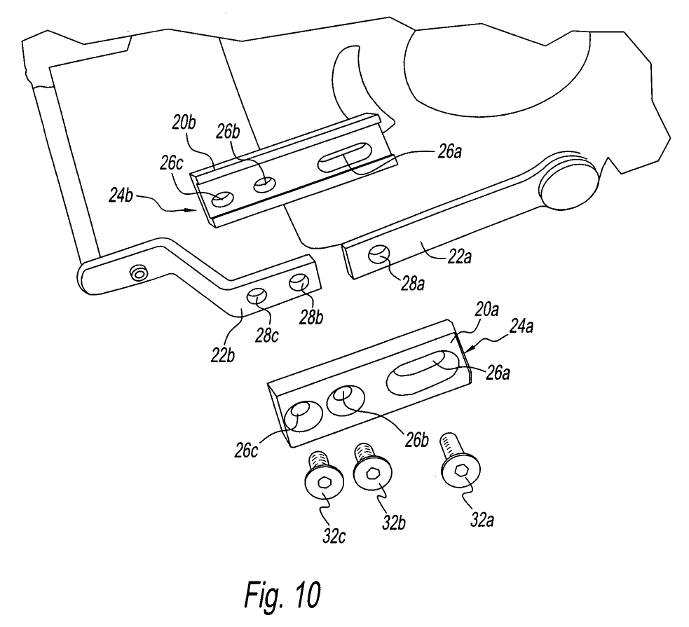

The present invention allows adjustment of the front standard 16 by providing adjustability to the support element, such as the supporting struts 22 of prior art camera 10 of FIGS. 1 and 2. In one embodiment, each supporting strut 22 is retrofitted with an adjustable adaptor 20, as shown in FIGS. 3, 4, 9 and 10. The adjustable adaptor 20 includes two identical sections 20a and 20b. Each section 20a or 20b has an axial channel 24a or 24b. The width of the channel 24a and 24b is slightly larger than the width of strut 22. Along each channel 20a or 20b are two generally round openings 26b and 26c and an elongated slot opening 26a. The round openings 26b and 26c may be internally threaded.

To retrofit the adjustable adaptor 20, each strut 22 first needs to be cut anywhere along its length, e.g. at cut A as shown in FIG. 2, to form struts 22a and 22b. A generally round aperture 28a is then drilled/tapped near the open end of strut 22a. Another aperture 28b or two apertures 28c are drilled/tapped near the open end of strut 22b.

The two identical sections 20a and 20b sandwich the open ends of struts 22a and 22b between and along channels 24a and 24b, with the openings 26b and 26c in alignment with apertures 28b and 28c, respectively. Screw 32b is inserted through opening 26b of section 20a, through aperture 28b and through opening 26b of section 20b. Screw 32c is inserted through opening 26c of section 20a, through aperture 28c and through opening 26c of section 20b. Alternative to screws 32b and 32c, nuts and bolts or other fastening means known to one skilled in the art can be used to fasten the adjustable adaptor 20 to the strut 22b. A bolt 32a is inserted through elongated slot opening 26a of section 20a, through aperture 28a and through elongated slot opening 26a of section 20b. A nut (not shown) engages the open end of bolt 32a to fixedly fasten the adjustable adaptor 20 to the strut 22c. Other fastening means known to one skilled in the art can also be used to fasten the adjustable adaptor 20 to the strut 22a. The elongated slot opening 26a allows strut 22a to be shortened or lengthened with respect to the adjustable adaptor 20. By shortening or lengthening strut 22 with adjustable adaptor 20, the front standard 16 of a camera can be adjusted to the proper position to ensure parallelism between the front standard 16 and the film plane.

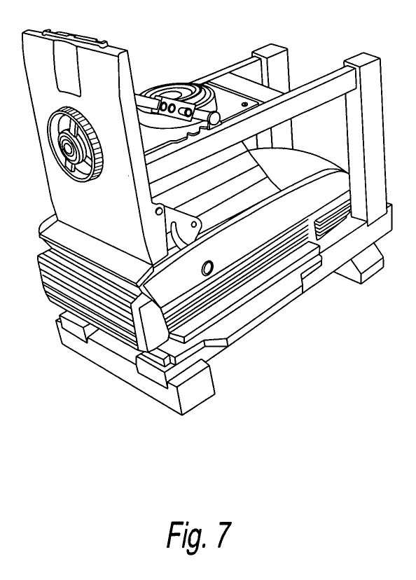

To facilitate adjustment of the front standard relative to the fixed film plane, a frame support 50 as shown in FIGS. 6 and 7 may be used. In one embodiment, frame support 50 is specifically designed for a camera 10′ having a Graflock type film holder 51 attached to the camera body 12 and the adjustable adaptor 20 mounted on the supporting strut 22. Minor modifications can be made to frame support 50 to accept different types of cameras. Frame support 50 includes two generally U-shape elements 52 and 54 on the horizontal plane, spaced apart and fixedly parallel to each other, and supported by vertical frame 56. Upper U-shape element 52 is smaller than the lower U-shape element 54. Each U-shape element 52 or 54 has two extension beams 52a and 52b and 54a and 54b, respectively. On each of the extension 54a or 54b, on the outer side surface is an axial groove 58.

The film holder 51 of camera 10′ is slid over and onto grooves 54 of extension beams 54a and 54b of lower U-shape element 54. The film holder 51 is then secured to the lower U-shape element 54 by manipulating locking plate 51a of the film holder 51. The front standard 16 rests on and between extension beams 52a and 52b of upper U-shape element 52. By moving the front standard 16 up and down by moving the focusing train 18 with the focusing knob (not shown), and using the upper U-shape element 52 as a guide for perfect parallelism, the adjustable adaptor 20 can be adjusted to ensure the front standard 16 is properly and evenly rested against upper U-shape element 52 for true parallelism between the front standard 16 and the film holder 51. Once parallelism is achieved, the bolt 32s and nut (not shown) are tightened to fix the length of the strut 22′.

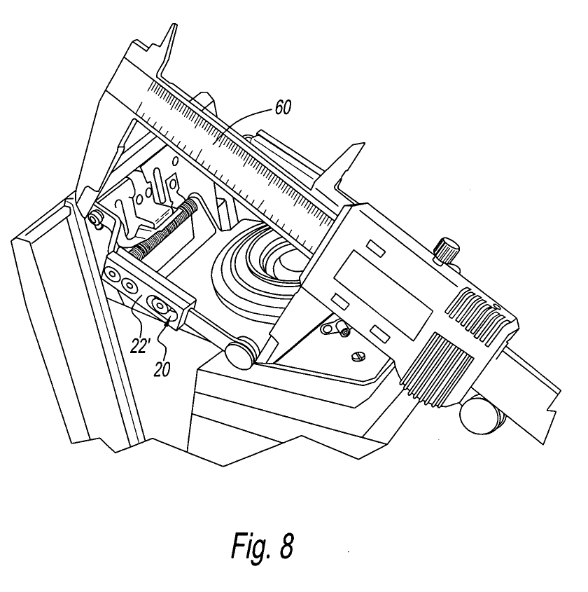

Once parallelism of the front standard 16 is achieved with respect to the film holder 51 by using the support frame 50 and method of the present invention, a precise linear measurement of the strut 22′ can be taken with a digital caliper 60 (as shown in FIG. 8). Each camera will have a different measurement. Such measurement(s) may be marked on the camera itself for future reference so that any later misalignment in parallelism can be determined and adjusted quickly without the need to using the support frame 51 and method of the present invention.

Although certain features of the invention have been illustrated and described herein, other better modifications and changes will occur to those skilled in the art. It is, therefore, to be understood that the appended claims are intended to cover all such modification and changes that fall within the spirit of the invention.

What I claim is:

1. A camera having a body, a front standard, a film plane, and comprising means for adjusting said front standard to obtain parallelism between said front standard and said film plane.

2. The camera of claim 1 wherein said front standard is supported by at least one strut and said adjusting means adjust the length of said at least one strut to obtain parallelism between said front standard and said film plane.

3. The camera of claim 2 wherein said adjusting means comprises at least one section having an axial channel with at least one generally round opening and at least one elongated slot opening.

4. The camera of claim 3 wherein each of said strut comprises two strut sections, with each strut section having at least one aperture, wherein said aperture of one strut section corresponds to said round opening and said aperture of the other strut section corresponds to said elongated slot opening, further comprising fastening means to secure said adjusting means to said strut sections.

5. A system for obtaining parallelism of a front standard with respect to a film plane of a camera, comprising:
a. means for adjusting said front standard with respect to said film plane; and
b. means for determining whether the front standard is parallel to said film plane.

6. The system of claim 5 wherein said determining means comprises:
a. at least two generally U-shape elements, each with two spaced apart extension beams; and
b. a vertical support holding said at least two U-shape elements on the horizontal plane, spaced apart and fixedly parallel to each other;
wherein said film plane is mounted between said extension beams of said lower U-shape element and said front standard rests on and between said extension beams of said upper U-shape element.

7. The system of claim 6 wherein each of said extension beams of said lower U-shape element has an axial groove along the outer side surface of said extension beam for receiving said film plane.

8. A method of adjusting a front standard to obtain parallelism with a film plane of a camera, wherein said front standard is supported by at least one supporting element, comprising the steps of:
a. providing means for adjusting said supporting element to lengthen or shorten said supporting element; and
b. providing means for determining whether said front standard is parallel to said film plane.

9. The method of claim 8 wherein said determining means comprises at least two generally U-shape elements, each with two spaced apart extension beams, and a vertical support holding said at least two U-shape elements on the horizontal plane, spaced apart and fixedly parallel to each other, further comprising the steps of:
c. mounting said film plane between said extension beams of said lower U-shape element; and
d. resting said front standard on and between said extension beams of said upper U-shape element.
